(19) United States
(12) Patent Application Publication
(10) Pub. No.: US 2011/0069766 A1
(43) Pub. Date: Mar. 24, 2011

(54) METHOD OF COMMUNICATING WITH USING ELECTRIC POWER LINE FOR MOBILE BODY

(75) Inventors: Akira Takahashi, Nisshin-city (JP); Masaki Takanashi, Nagoya-city (JP); Tsutayuki Shibata, Miyoshi-city (JP)

(73) Assignee: DENSO CORPORATION, Kariya-city (JP)

(21) Appl. No.: 12/888,497

(22) Filed: Sep. 23, 2010

(30) Foreign Application Priority Data
Sep. 24, 2009 (JP) 2009-218728
Aug. 18, 2010 (JP) 2010-183175

(51) Int. Cl. H04B 3/00

(52) U.S. Cl. 375/257

(57) ABSTRACT

A method of communicating with using an electric power line for a mobile body so that a first device transmits first information to a second device includes: coupling the first device with multiple first coupling points in an electric power line network; coupling the second device with multiple second coupling points; transmitting second information about transmission characteristics from the second device to the first device; modulating multiple transmission waves to be transmitted from the first device via the transmission points by the first device with using a transmission diversity method based on the second information; and demodulating multiple reception waves received by the second device via the reception points by the second device with using a reception diversity method.

### CROSS REFERENCE TO RELATED APPLICATIONS

This application is based on Japanese Patent Applications No. 2009-218728 filed on Sep. 24, 2009, and No. 2010-183175 filed on Aug. 18, 2010, the disclosures of which are incorporated herein by reference.

### FIELD OF THE INVENTION

The present invention relates to a method of communicating with an electric power line for a mobile body. The mobile body includes a bundle of multiple electric power lines retrieved from a battery via a junction box and divided into multiple lines.

### BACKGROUND OF THE INVENTION

In a mobile body such as an automotive body, multiple ECUs provide a high speed LAN with high communication accuracy in order to control an engine or a brake system, which relate to safety. On the other hand, in a vehicle navigation system, for, example, when an image of a rear side of the vehicle is displayed on a monitor, the communication accuracy may be not high. However, it is necessary to transmit a lot of image data, which is shot by a camera on a rear side of the vehicle, to the monitor near a driver's seat with comparatively high speed. Thus, a high speed communication network, which is independent from the high speed LAN for the safety, is necessary.

A DC battery in the mobile body is coupled with each device arranged at a certain place of the mobile body through an electric power line. Each device is energized by the DC battery. The electric power line may be used as the high speed communication means.

A method of communicating with the electric power line is disclosed in, for example, JP 4104394. JP 4104394 teaches an electric power line communication device, in which a transmission device is connected to a electric power line at one point, and a receiver is connected to the electric power line at two points. The technique disclosed in JP 4104394 provides reception diversity.

The technique in JP 4104394 merely provides the reception diversity. However, the improvement of communication accuracy is much required for an electric power line communication method for a mobile body, which is disposed in very noisy environment. For example, when large diversity gain is required, multiple reception lines may be necessary. Further, when the device provides only the reception diversity, the lines may not be sufficient. Furthermore, the dimensions of the circuit for the receiver may be large.

Further, in the electric power line communication method, leakage of an electro-magnetic wave may affect on devices around the lines, and therefore, it is necessary to reduce the electric power, which is transmitted through the lines.

### SUMMARY OF THE INVENTION

In view of the above-described problem, it is an object of the present disclosure to provide a method of communicating with using an electric power line for a mobile body.

According to a first aspect of the present disclosure, a method of communicating with using an electric power line for a mobile body so that a first transmitting and receiving device transmits first information to a second transmitting and receiving device includes: coupling the first transmitting and receiving device in the mobile body with a plurality of first coupling points, which are arranged in an electric power line network including a plurality of electric power lines; coupling the second transmitting and receiving device in the mobile body with a plurality of second coupling points which are arranged in the electric power line network; transmitting second information about transmission characteristics from the second transmitting and receiving device to the first transmitting and receiving device; modulating a plurality of transmission waves, which are to be transmitted from the first transmitting and receiving device via the transmission points, by the first transmitting and receiving device with using a transmission diversity method based on the second information about transmission characteristics; and demodulating a plurality of reception waves, which are received by the second transmitting and receiving device via the reception points, by the second transmitting and receiving device with using a reception diversity method.

When the multiple first and second coupling points are arranged in the electric power line network, both of the transmission diversity method and the reception diversity method can be performed. Further, the MIMO technique can be available. Thus, the transmission electric power is reduced, and the communication having good bit error rate characteristics is established. Thus, a signal leakage amount is reduced.

According to a second aspect of the present disclosure, a method of communicating with using an electric power line for a mobile body so that a first transmitting and receiving device transmits a first information signal to the second transmitting and receiving device includes: coupling the first transmitting and receiving device in the mobile body with a plurality of first coupling points, which are arranged in an electric power line network including a plurality of electric power lines; coupling the second transmitting and receiving device in the mobile body with a plurality of second coupling points, which are arranged in the electric power line network; modulating a predetermined data by the first transmitting and receiving device with using a multiple-input multiple-output technique and a orthogonal frequency division multiplexing method, wherein the predetermined data is a well-known data; transmitting the predetermined data from the first transmitting and receiving device to the second transmitting and receiving device; demodulating the predetermined data by the second transmitting and receiving device with using the multiple-input multiple-output technique and the orthogonal frequency division multiplexing method; determining transmission characteristics of each electric power line with a corresponding first coupling point and a corresponding second coupling point based on the predetermined data by the second transmitting and receiving device; determining a transmission level and a frequency of a sub carrier based on the transmission characteristics by the second transmitting and receiving device; modulating a second information signal by the second transmitting and receiving device with using the multiple-input multiple-output technique and the orthogonal frequency division multiplexing method, wherein the second information signal provides the transmission characteristics, which includes the transmission level and the frequency of the sub carrier; transmitting the second information signal from the second transmitting and receiving device to the first transmitting and receiving device; modulating the first information signal based on the transmission characteristics by the first transmitting and receiving device with using the multiple-input multiple-output technique and the orthogonal frequency division multiplexing method; transmitting the first information signal from the first transmitting and receiving device to the second transmitting and receiving device; and demodulating the first information signal by the second transmitting and receiving device with using the multiple-input multiple-output technique and the orthogonal frequency division multiplexing method.

When the multiple first and second coupling points are arranged in the electric power line network, both of the transmission diversity method and the reception diversity method can be performed. Further, the MIMO technique can be available. Thus, the transmission electric power is reduced, and the communication having good bit error rate characteristics is established. Thus, a signal leakage amount is reduced.

According to a third aspect of the present disclosure, a method of communicating with using an electric power line for a mobile body includes: coupling a transmitting device in the mobile body with a plurality of transmission points, which are arranged in an electric power line network including a plurality of electric power lines; coupling a receiving device in the mobile body with a plurality of reception points, which are arranged in the electric power line network; and demodulating a plurality of reception waves, which are received by the receiving device via the reception points, by the receiving device with using a reception diversity method.

When the multiple transmission points and multiple reception points are arranged in the electric power line network, both of the transmission diversity method and the reception diversity method can be performed. Further, the MIMO technique can be available. Thus, the transmission electric power is reduced, and the communication having good bit error rate characteristics is established. Thus, a signal leakage amount is reduced.

### BRIEF DESCRIPTION OF THE DRAWINGS

The above and other objects, features and advantages of the present invention will become more apparent from the following detailed description made with reference to the accompanying drawings. In the drawings:

FIG. 1A is a diagram showing an example of an electric power line communication for a mobile body, and FIG. 1B is a diagram showing another example of the electric power line communication for the mobile body;

FIG. 2A is a diagram showing a connection relationship between a first transmitting and receiving device and a second transmitting and receiving device in an electric power line network for a mobile body, and FIG. 2B is a diagram showing an arrangement of two transmission points and two reception points in the electric power line network of a vehicle;

FIG. 3 is a diagram showing a graph of a relationship between a frequency of an electric power line network of a vehicle and measurement results of a transmission power;

FIG. 4 is a diagram showing a graph of simulation results based on the measurement results in FIG. 3;

FIG. 5 is a diagram showing a flowchart of a process in the first transmitting and receiving device;

FIG. 6 is a diagram showing a flowchart of a process in the second transmitting and receiving device; and

FIG. 7 is a diagram showing frequency distribution of other frequency division multiplexing forms

### DETAILED DESCRIPTION OF THE PREFERRED EMBODIMENTS

The present inventors have found that it is possible to communicate with using a virtual transmission passes having the number of M multiplied by N in a electric power line network for a vehicle or the like. The virtual transmission passes are prepared by connecting between M points and N points. The M points and N points are preliminary determined, and M and N represent non-negative integers, respectively. For example, electric power lines connecting between a DC battery disposed in a mobile body such as a vehicle and a device that is energized by the battery are bundled. The bundled lines are disposed in the mobile body. Thus, electro-magnetic induction between the lines may be generated. In view of this point, the present inventors have found that MIMO (multiple-input multiple-output) technique is available in electric power line communication for a mobile body.

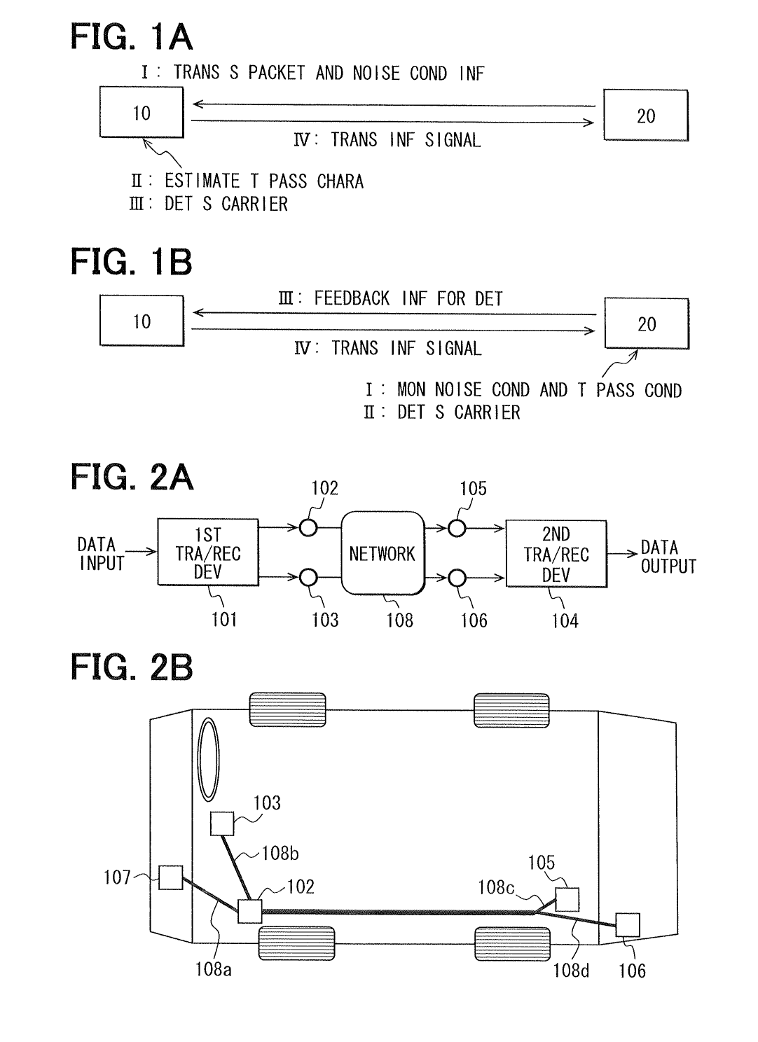

FIG. 1A is a diagram showing an example of an electric power line communication for a mobile body, and FIG. 1B is a diagram showing another example of the electric power line communication for the mobile body.

The electric power line communication in FIG. 1A is performed such that, in a first step, a sounding packet as a well-known signal and noise condition information of a second transmitting and receiving device 20 are transmitted from the second transmitting and receiving device 20 to the first transmitting and receiving device 10. Next, in a second step, the first transmitting and receiving device 10 estimates transmission pass characteristics, and further, in a third step, the device 10 determines a sub carrier and electric power, which are used for transmission. Then, in a fourth step, the first transmitting and receiving device 10 transmits an information signal to the second transmitting and receiving device 20.

The electric power line communication in FIG. 1B is performed such that, in a first step, the second transmitting and receiving device 20 monitors the noise condition and the transmission pass condition. Then, in a second step, the device 20 determines the sub carrier and the electric power, which are used for the transmission. The second transmitting and receiving device 20 feedbacks information for determining the transmission method, the sub carrier and the electric power. Then, the first transmitting and receiving device 10 determines the transmission method, the sub carrier and the electric power. With using the determined transmission method, the determined sub carrier and the determined electric power, the first transmitting and receiving device 10 transmits the information signal to the second transmitting and receiving device 20.

### First Embodiment

FIGS. 2A and 2b shows a relationship among a first transmitting and receiving device 101, a second transmitting and receiving device 104 and an electric power line network 108a-108d. In the present embodiment, a MIMO communication system having a two-by-two system is provided. As shown in FIG. 2A, two terminals of the first transmitting and receiving device 101 are connected to two terminals of a junction box 102 and a cigarette lighter socket 103 via the electric power line network 108, respectively. Two terminals of the second transmitting and receiving device 104 are connected to two terminals of a rear seat room lamp 105 and a rear hatch tail lamp 106 via the electric power line network 108, respectively. In this embodiment, a communication method is a OFDM (orthogonal frequency division multiplexing) form. The first transmitting and receiving device 101 includes an analog circuit such as a RF modulator, a RF demodulator and an amplifier. The device 101 further includes a computer system for controlling each element and for performing digital modulation and digital demodulation such as discrete inverse Fourier transform and discrete Fourier transform. The second transmitting and receiving device 104 includes an analog circuit such as a RF modulator, a RF demodulator and an amplifier. The device 104 further includes a computer system for controlling each element and for performing digital modulation and digital demodulation such as discrete inverse Fourier transform and discrete Fourier transform.

The electric power line network 108 is shown in FIG. 2B. Specifically, the junction box 102 and the cigarette lighter socket 103 are disposed on a front side of a mobile body. The junction box 102 is connected to a battery 107 for energizing via an electric power line 108a. Further, the junction box 102 is connected to the cigarette lighter socket 103 via an electric power line 108b. A rear seat room lamp 105 and a rear hatch tail lamp 106 are disposed on a rear side of the mobile body. The room lamp 105 is connected to the junction box 102 via an electric power line 108c. The tail lamp 106 is connected to the junction box 102 via an electric power line 108d. The electric power lines 108a-108d, the junction box 102, the cigarette lighter socket 103, the battery 107, the room lamp 105 and the tail lamp 106 provide the electric power line network 108. The network 108 may further include other devices and other electric power lines. Each of the junction box 102, the cigarette lighter socket 103, the room lamp 105 and the tail lamp 106 includes a terminal for connecting to one of two terminals of the first and second transmitting and receiving devices 101, 104.

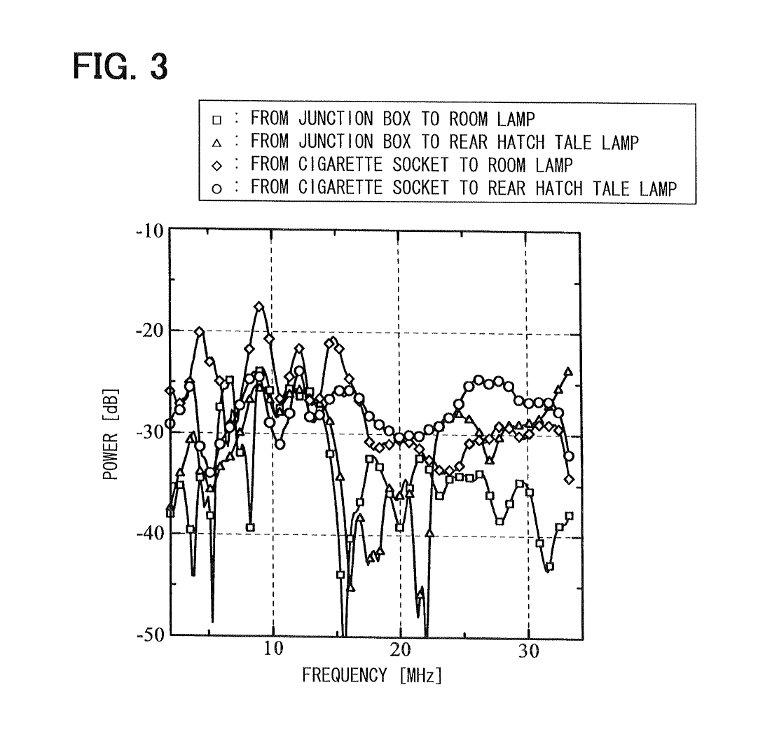

The effects of the above electric power line communication in FIGS. 1A and 1B are described as follows. Specifically, measurements and simulation are performed. FIG. 3 shows measurement results of a transmission power with respect to a frequency, which is one of transmission characteristics in an electric power line network of a vehicle. A transmission point is arranged near a dash-board of a driver's seat in the vehicle. Specifically, one of transmission points is arranged at the junction box 102, and another one of the transmission points is arranged at the cigarette lighter socket 103. One of reception points is arranged at the room lamp 105 of the rear seat, and another one of the reception points is arranged at the rear hatch tail lamp 106.

The transmission point is arranged at the junction box 102, and the reception point is arranged at the room lamp 105 so that communication from the junction box transmission point to the room lamp transmission point is defined as a square.

The transmission point is arranged at the junction box 102, and the reception point is arranged at the tail lamp 106 so that communication from the junction box transmission point to the tail lamp transmission point is defined as a triangle.

The transmission point is arranged at the cigarette lighter socket 103, and the reception point is arranged at the room lamp 105 so that communication from the cigarette lighter socket transmission point to the room lamp transmission point is defined as a diamond shape.

The transmission point is arranged at the cigarette lighter socket 103, and the reception point is arranged at the tail lamp 106 so that communication from the cigarette lighter socket transmission point to the tail lamp transmission point is defined as a circle.

Here, the square, the triangle, the diamond shape and the circle are merely presented to distinguish from each other. Thus, there is no specific meaning of a sign, for example with respect to a frequency.

Each electric power line 108b-108d of the cigarette lighter socket 103, the room lamp 105 and the tail lamp 106 is connected to the battery 107 through a switch and the like in the junction box 102. Specifically, it is not necessarily the case that a transmission pass, which is virtually formed in combination with above four points, is directly formed from a wiring with a switch in an on state.

Specifically, even if a switch turns off, the transmission signal from the transmission point at the cigarette lighter socket 103 and the transmission signal from the transmission point at the junction box 102 are transmitted to the electric power line 108c of the room lamp 105 and the electric power line 108d of the tail lamp 106, respectively, directly through the junction box 102 or with using electro-magnetic induction.

Alternatively, the transmission signal from the transmission point at the cigarette lighter socket 103 and the transmission signal from the transmission point at the junction box 102 are directly transmitted to the electric power line 108c to the room lamp 105 through the switch in the junction box 102, which turns on. Although the transmission signal from the transmission point at the cigarette lighter socket 103 and the transmission signal from the transmission point at the junction box 102 are not directly transmitted to the electric power line 108d to the tail lamp 106 through the switch in the junction box 102, which turns off, two transmission signals may be transmitted from the electric power line 108c to the room lamp 105 to the electric power line 108d to the tail lamp 106 when the electro-magnetic induction is generated between the electric power line 108c to the room lamp 105 and the electric power line 108d to the tail lamp 106.

Thus, the transmission points are arranged at the junction box 102 and the cigarette lighter socket 103, which are comparatively arranged on a front side of a compartment of the vehicle. The reception points are arranged at the room lamp 105 and the tail lamp 106, which are comparatively arranged on a rear side of the vehicle. Thus, a signal can be transmitted from any one of two transmission points to any one of two reception points directly through the junction box 102 or with using the electro-magnetic induction near the junction box 102. Thus two-by-two i.e. four different transmission passes are provided.

As shown in FIG. 3, the following points are obtained.

When the transmission point is arranged at the junction box 102, and the reception point is arranged at the room lamp 105 or the tail lamp 106, an attenuation amount almost exceeds −30 dB. In some cases with certain frequency, the attenuation amount exceeds −40 dB.

When the transmission point is arranged at the cigarette lighter socket 103, and the reception point is arranged at the room lamp 105 or the tail lamp 106, an attenuation amount does not exceeds −35 dB. Specifically, the attenuation amount is in a range between −30 dB and −20 dB.

Simulation of an error rate is performed based on the measurement results in FIG. 3 with using a MIMO technique when the transmission points are arranged at the junction box 102 and the cigarette lighter socket 103, and the reception points are arranged at the room lamp 105 and the tail lamp 106.

Conditions of the simulation are as follows. The first modulation method is defined as 16QAM (quadrature amplitude modulation), and the second modulation method is defined as OFDM (orthogonal frequency division multiplexing).

The number of sub carriers is 180, and a distance between carriers is 156.25 kHz. Thus, all frequency zone of a usage frequency band of an electric power line communication (PLC) authorized for domestic use in Japan in a range between 2 MHz and 30 MHz is utilized. Here, to be precise the usage frequency band is in a range between 2.0 MHz and 29.96875 MHz.

The error correction sign is a convolutional code, a coding rate is a half, and a constraint length is seven. These comply with Code 802.11a of IEEE Standards for wireless LAN.

An error decoding method is defined by the Viterbi algorithm.

In the MIMO transmission method, a transmission selection diversity method is used, and the transmission and reception points are defined by two by two. In the diversity method, the transmission points are selected to obtain a transmission pass having excellent performance for each sub carrier on a transmission side.

A noise is assumed to be an additive white Gaussian noise.

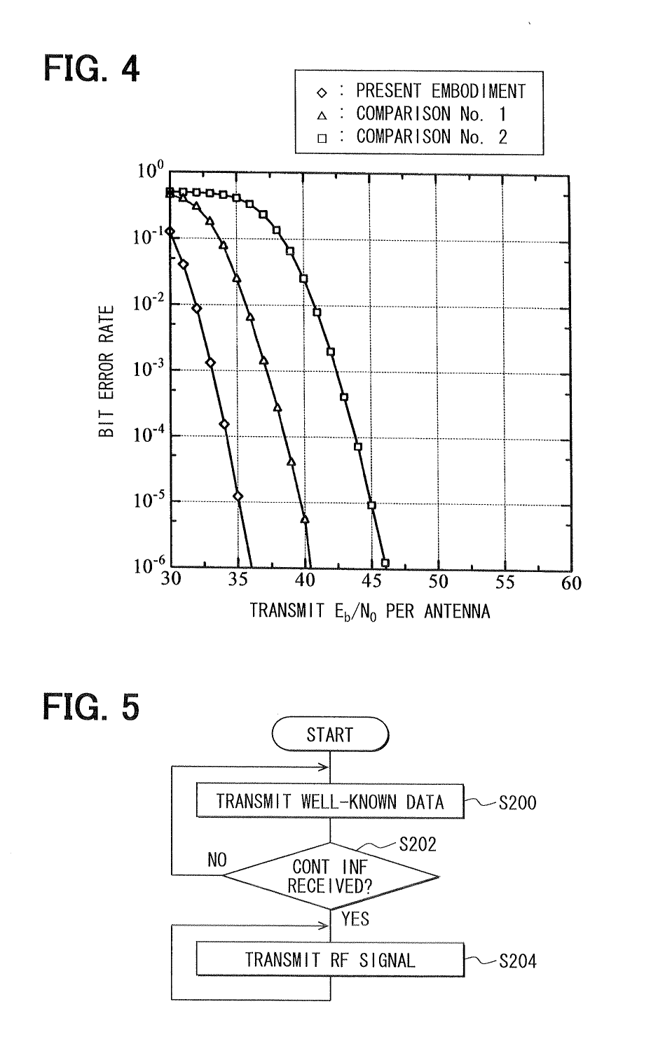

FIG. 4 shows a graph of simulation results of bit error rate characteristics based on the measurement results in FIG. 3. The results according to the present embodiment are shown as a diamond shape. The results according to a comparison No. 1 are shown as a square and the results according to a comparison No. 2 are shown as a triangle.

The comparison No. 1 provides a case where the transmission point is only arranged at the junction box 102 and the reception point is only arranged at the room lamp 105. The comparison No. 2 provides a case where the transmission point is only arranged at the junction box 102, and the reception points are arranged at the room lamp 105 and the tail lamp 106.

In the present embodiment and the comparison No. 2, two reception signals on the reception side are combined with a maximum ratio. Here, in the comparison No. 2, although the MIMO method, i.e., the transmission selection diversity method is not used, it is assumed that one of transmission antennas on the transmission side is removed so that the transmission electric power is set to be zero, and other conditions are same as the present embodiment. In the comparison No. 1, although the diversity is not performed, it is assumed that one of the reception antennas on the reception side is removed so that the reception electric power is set to be zero, and other conditions are same as the comparison No. 2.

As shown in FIG. 4, the present embodiment is performed such that the transmission and reception points are defined by two-by-two, and the MIMO transmission method (the transmission selection diversity method) is used. The bit error rate (i.e., BER) in the present embodiment is about 10⁻³ when the transmission ratio Eb/N₀ per antenna is 33 dB. The BER in the present embodiment is about 10⁻⁵ when the transmission ratio Eb/N₀ per antenna is 35 dB.

On the other hand, in the comparison No. 1 without performing diversity on both sides of the transmission and reception side, the BER is about a half when the transmission ratio Eb/N₀ per antenna is 35 dB, and the BER is about 10⁻³ when the transmission ratio Eb/N₀ per antenna is 42 dB.

In the comparison No. 2 with performing diversity on the reception side only, the BER is about 2×10⁻² when the transmission ratio Eb/N₀ per antenna is 35 dB, and the BER is about 10⁻³ when the transmission ratio Eb/N₀ per antenna is 37 dB.

Thus, the transmission electric power reduction in the present embodiment with performing the MIMO transmission method (i.e., the transmission selection diversity method) is smaller by 4 dB than that in the comparison No. 2, and smaller by 9 dB than the comparison No. 1.

The reason why the effects of the MIMO technique are obtained is that the transmission points are arranged at the junction box 102 and the cigarette lighter socket 103 disposed on the front side of the vehicle, and the reception points are arranged at the room lamp 105 and the tail lamp 106 disposed on the rear side of the vehicle. Specifically, the electric lines for the socket 103, the room lamp 105 and the tail lamp 106 are connected to the battery 107 via the switch and the like in the junction box 102. The transmission signal from the transmission point at the socket 103 near the junction box 102 and the transmission signal from the transmission point at the junction box 102 are transmitted to the electric power lines to the room lamp 105 and to the tail lamp 106 directly through the junction box 102 or by electro-magnetic induction near the junction box 102.

Alternatively, the transmission signal from the transmission point at the socket 103 and the transmission signal from the transmission point at the Junction box 102 are directly transmitted to the electric power line 108c of the room lamp 105, which is switched on, and the transmission signal from the transmission point at the socket 103 and the transmission signal from the transmission point at the junction box 102 are not directly transmitted to the electric power line 108d of the tail lamp 106, which is switched off. the above transmission signals are transmitted from the electric power line 108c of the room lamp 105 to the electric power line 108d of the tail lamp 106 in a section, in which the electro-magnetic induction is generated between the electric power line 108c of the room lamp 105 and the electric power line 108d of the tail lamp 106.

Thus, the transmission points are arranged at the junction box 102 and the socket 103, which are comparatively arranged on the front side of the vehicle, and the reception points are arranged at the room lamp 105 and the tail lamp 106, which are comparatively arranged on the rear side of the vehicle. Thus, a signal can be transmitted from any one of two transmission points to any one of two reception points directly through the junction box 102 or with using the electro-magnetic induction near the junction box 102.

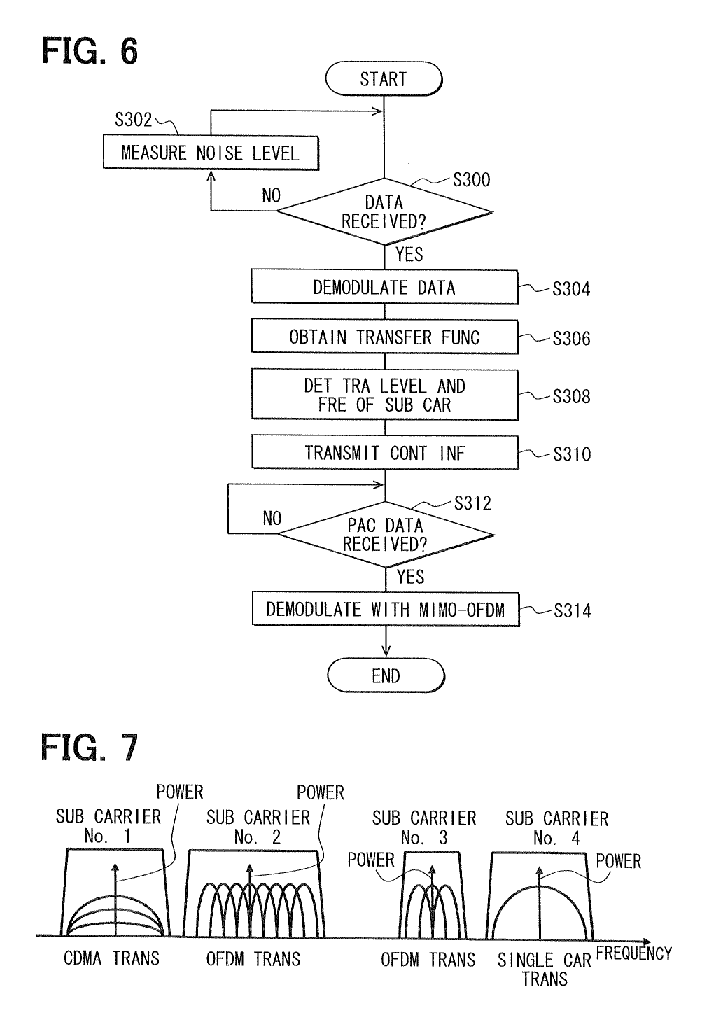

Next, a device used for the MIMO-OFDM transmission method with a two-by-two system will be explained. The process executed by the computer system in the first transmitting and receiving device 101 is shown in FIG. 5, and the process executed by the computer system in the second transmitting and receiving device 104 is shown in FIG. 6. First, transmission pass characteristics of each transmission pass such as a transfer function and a noise level are measured. In step S200, before a packet data is transmitted from the first transmitting and receiving device 101, a well-known data row is modulated by the MIMO-OFDM method, and then, the data row is transmitted to the second transmitting and receiving device 104.

In step S300, the second transmitting and receiving device 104 is in a stand-by mode until the well-known data row is received. In the stand-by mode, in step S302, the noise level of each transmission pass is measured at each frequency. When the data row is received, in step S304, the data row in the MIMO-OFDM type is demodulated, so that the amplitude and the phase of the data, which is transmitted through each pass, are obtained. Here, the amplitude and the phase of the data row before being transmitted through the pass is known. Accordingly, based on the ratio between the demodulated complex data and the complex data before being transmitted, a complex transfer function of each pass is obtained. Thus, in step S306, the transfer function of each pass is calculated. Specifically, the absolute value of the transfer function is calculated as the characteristics shown in FIG. 3.

Next in step S308, based on the noise level of each frequency, which is measured, and the absolute value of the transfer function (i.e., attenuation of the transmission pass), the transmission level, at which the S/N ratio equal to or larger than a predetermined value is obtained, and the frequency of the sub carrier are determined. Thus, when the transmission level is determined based on the characteristics obtained from FIG. 3, the frequency characteristics of the reception level is determined. Thus, the S/N ratio of the reception signal with respect to the transmission level is determined at each frequency. Further, the frequency of the sub carrier for providing the S/N ratio larger than the predetermined value is determined. The determination of the frequency of the sub carrier is performed at each transmission point. Specifically, there are two reception points with respect to one transmission point, and there are two transmission passes with respect to the one transmission point. Thus, the frequency for providing the S/N, ratio larger than the predetermined value in one transmission pass having a smaller S/N ratio is determined. When the transmission level is made high, the S/N ratio of the reception signal is improved. However, the electric power loss increases. Accordingly, the transmission electric power is determined to be minimum in a range, in which the predetermined number of the sub carriers for obtaining the predetermined S/N ratio is secured. Thus, a group of frequencies of the sub carriers determined in each transmission point and information about the transmission level are transmitted as control information to the first transmitting and receiving device 101 in step S310. The control information may be modulated by the MIMO-OFDM method with using the determined transmission level and the group of the frequencies of the sub carriers, and may be transmitted. The control information corresponds to the information relating to the transmission characteristics. When the control information is transmitted to the first transmitting and receiving device 101, the control information may be transmitted through one of the transmission passes, which has the highest transmission quality. When the well known data is stored in a top end of the control information, the transfer function of the transmission pass can be obtained in the first transmitting and receiving device 101. Thus, the control information is demodulated.

In step S202, the first transmitting and receiving device 101 receives the control information from the second transmitting and receiving device 104. When the device 101 receives the information from the device 104, the information is modulated by the MIMO-OFDM method in step S204, and then, the device 101 transmits the packet data, which is necessary to transmit, to the second transmitting and receiving device 104. At this time, the frequency of the sub carrier that is used for modulation is determined at each transmission point based on the received control information. The amplification of the amplifier is adjusted so that the signal level transmitted from the first transmitting and receiving device 101 through each transmission point corresponds to the transmission level determined from the control information. Thus, the packet data is transmitted to the electric power line network 108. In this case, the number of sub carriers is defined as 2ⁿ in view of the FFT calculation. The disuse sub carrier is defined as a null carrier, and thus the calculation is performed.

The second transmitting and receiving device 104 is in a stand-by state until the packet data is received. When the packet data is received, in step S314, the packet data is demodulated by the MIMO-OFDM method with using the transfer function (i.e., transfer matrix) of each transmission pass obtained in step S306. Thus, the data is transmitted from two transmission points independently, and demodulated independently. After the transfer function of the transmission pass is obtained, in step S204, the packet data is repeatedly transmitted based on the control information which is transmitted from the second transmitting and receiving device 104. In steps S312, S314, the second transmitting and receiving device 104 demodulates the reception signal at every time when a series of the packet data is received.

The transmitting process in the first transmitting and receiving device 101 for transmitting the well-known data to the second transmitting and receiving device 104 may be performed to relate to an interrupt process from step S200, the well-known data used for obtaining the transfer function of the transmission pass in steps S200, S202 at a timing when the characteristics of the transmission pass is changed. The transmitting process in the second transmitting and receiving device 104 for transmitting the control information to the first transmitting and receiving device 101 and the process for obtaining the transmission pass in steps S302 to S310 may be performed to relate to the interrupt process from step S300 at a timing when the characteristics of the transmission pass is changed. Thus, the MIMO technique with using the transmission selection diversity for selecting the transmission point is realized in each sub carrier.

(Modifications)

In the above embodiment, the second transmitting and receiving device 104 determines the frequency of the sub carrier and the transmission level at each transmission point, and these are transmitted as the control information to the first transmitting and receiving device 101. Alternatively, the noise level measured by the second transmitting and receiving device 104 and the absolute value of the transfer function of each transmission pass may be transmitted to the first transmitting and receiving device 101, and the first transmitting and receiving device 101 may determine the transmission level and the frequency of the sub carrier in each transmission point.

Alternatively, the second transmitting and receiving device 104 may transmit the well known data and the noise level for obtaining the transfer function of the transmission pass to the first transmitting and receiving device 101. The transmitting and receiving device 101 demodulates the well-known data, so that the transfer function of each transmission point is obtained. Thus, the transmission level and the frequency of the sub carrier are determined in each transmission point.

In the above embodiment, the transmission point is determined in each sub carrier. Alternatively, a common sub carrier may exist among multiple transmission points. Further, in the above embodiment, space division multiplexing method is used so that the transmission is performed with using all of four transmission passes. Specifically, the transmission is performed with using two transmission passes with respect to one transmission point. Alternatively, the transmission level and the sub carrier may be determined such that a S/N ration of a signal having the S/N ratio larger among the reception signals at two reception points in each sub carrier exceeds the reference S/N value In this case, the transmission pass having larger S/N ratio is selected between two transmission passes by the selection reception diversity method. Alternatively, the transmission level and the sub carrier of a signal may be determined in each transmission point to exceed the reference S/N ratio in each sub carrier, the signal processed from the reception signals at two reception points by a combining diversity method such as maximum ratio combining method.

Alternatively, one of two transmission points having excellent transmission quality may be determined in each frequency of each sub carrier. Then, one packet data is transmitted in a divided manner from the selected transmission point. In this case, the transmission selection diversity with selecting the transmission pint in each frequency is performed. In this case, the disuse sub carrier is treated as the null carrier in the FFT process.

Further, since the same data in each sub carrier is received at two reception points, the second transmitting and receiving device 104 combines two data with maximum ratio in each sub carrier.

Alternatively, the data having higher reception level may be selected between two reception points in each sub carrier. In the above embodiment, the group of frequencies of the sub carrier is determined in each transmission point. Alternatively, the group of frequencies may be commonly selected among all sub carriers so as to obtain the predetermined S/N ratio.

Alternatively, in the MIMO technique with the above modulation method, a delay diversity method that provides different transmission delay time in each transmission point may be used. Alternatively, a space-time block coding (i.e., STBC) for coding with using multiple transmission points may be used.

Alternatively, the reception diversity method may be an equal gain combining method for combining and uniforming the amplitude and the phase of the reception electric power, or a selection combining diversity method for receiving only the signal of the reception point having the most excellent S/N ratio, in addition to the maximum ratio combining method.

In the above embodiment, the OFDM method is used. Alternatively, as shown in FIG. 7, in the CDMA transmission method and the single carrier transmission method, there is one carrier. Since the frequency division multiplexing method is executed, the carrier used in each band is defined as a sub carrier. Accordingly, the sub carrier is used for the OFDM method. Further, the carrier used in each modulation method, in which the frequency division multiplexing method is executed, is also the sub carrier. In FIG. 7, the CDMA transmission method, the OFDM transmission method, another OFDM transmission method and the single carrier transmission method are multiplexed in frequency division manner. The modulation method may be changed at each transmission point in each frequency band or at each frequency in each sub carrier. Even when the modulation method is changed at each transmission point, or even when the modulation method is changed in each frequency at the same transmission point, interference on the reception side is prevented since the modulation method is separated in the frequency band.

In the above embodiment, the OFDM method is used for the secondary modulation method. Alternatively, a spread spectrum method (SS method) may be used for the secondary modulation method. In this case, the transmission electric power in a case where the MIMO transmission method such as the transmission selection diversity method is applied according to the present embodiment is reduced, compared with a case where only the reception diversity method is applied and a case where the diversity method is not applied on both sides of the transmission and reception sides.

In the above embodiment, two terminals of the first transmitting and receiving device 101 are connected to the terminal of the junction box 102 and the terminal of the cigarette lighter socket 103, respectively. Two terminals of the second transmitting and receiving device 104 are connected to the terminal of the rear seat room lamp 105 and the terminal of the rear hatch tail lamp 106. When main data is transmitted from a rear side to a front side of the vehicle, two terminals of the first transmitting and receiving device 101 may be connected to the terminal of the rear seat room lamp 105 and the terminal of the rear hatch tail lamp 106, and two terminals of the second transmitting and receiving device 104 may be connected to the terminal of the junction box 102 and the terminal of the cigarette lighter socket 103, respectively.

In view of the results shown in FIG. 3, the following points are provided.

Specifically, when the reception electric power in all frequency band is higher than a threshold value, as shown in the diamond shape in FIG. 3, the secondary modulation method is set to be the OFDM method when the transmission from the first transmitting and receiving device 101 to the second transmitting and receiving device 104 is performed. Further, all primary modulation method is set to be 64 QAM method.

When the reception electric power in a part of or all of the sub carriers goes down, he primary modulation method in the part of or all of the sub carriers is switched from the 64 QAM to 16 QAM, QPSK (quadrature phase shift keying) or BPSK (binary phase shift keying) in this order. Further, the disuse sub carrier is set. Alternatively, the bit length of the error correction code is set to be variable, and the redundant amount increases when the reception electric power goes down.

Further, when the number of disuse sub carriers exceeds a predetermined number, the secondary modulation method is switched from the OFDM method to the SS method when the transmission from the first to second transmitting and receiving devices is performed.

When the transmission characteristics are not good, as shown in the square in FIG. 3, the above features may be applied.

The above features can be performed with using, for example, a conventional adaptive modulation technique.

In the present embodiment, multiple transmission pints and multiple reception points are arranged in an electric power line network for mobile body, and the transmission device and the reception device are connected to the transmission points and the reception points. Alternatively, multiple first connection points and multiple second connection points are arranged in the electric power line network, and the first transmitting and receiving device and the second transmitting and receiving device are connected to the first and second connection points. Alternatively, it is not necessary to connect the terminal of the reception device for receiving main data on the reception side directly to the electric power line network. Specifically, a part of or all of the terminals of the receiving device or the terminals of the second transmitting and receiving device may be connected to the transmission pass, which generates sufficient electro-magnetic induction with the transmission pass in the electric power line network for the high frequency signal. Alternatively, a part of or all of the terminals of the receiving device or the terminals of the second transmitting and receiving device may be coupled electro-magnetically with the transmission pass, which generates sufficient electro-magnetic induction with the transmission pass in the electric power line network for the high frequency signal. In this case, the transmission pass in the electric power line network and the external transmission pass may generate directly electro-magnetic induction. Alternatively, the transmission pass in the electric power line network and the external transmission pass may generate indirectly electro-magnetic induction via a certain metal portion for providing the mobile body.

When a digital monitoring image in each part of the mobile body is displayed on a vehicle navigation monitor of the vehicle, the above features are suitably used.

The above disclosure has the following aspects.

According to a first aspect of the present disclosure a method of communicating with using an electric power line for a mobile body includes: coupling a transmitting device in the mobile body with a plurality of transmission points, which are arranged in an electric power line network including a plurality of electric power lines; coupling a receiving device in the mobile body with a plurality of reception points which are arranged in the electric power line network; and demodulating a plurality of reception waves, which are received by the receiving device via the reception points, by the receiving device with using a reception diversity method.

Here, the electric power line is connected with a high frequency signal leased line via a filter or the like at the transmission point and the reception point. Thus, the transmission points and the reception points may correspond to multiple transmission antennas and multiple reception antennas.

The electric power line network connects a battery and multiple devices in the mobile body. The network includes multiple electric power lines, which include multiple branches, switches and the like. The network includes M transmission points and N reception points so that virtual high frequency passes having the number of M multiplied by N. For example, when multiple electric power lines extends from the battery via multiple branches and switches, even if the switch turns off, the high frequency wave can flow through the lines. Further, the high frequency wave can transmits from one line to another line because of the electro-magnetic induction between two adjacent lines or electro-static induction. When the transmission points and the reception points are arranged in the electric power line network, the high frequency passes may be formed. The high frequency passes has the number of passes, which is calculated by multiplying the number of the transmission points by the number of reception points.

In general, when the passes are coupled with each other in a high frequency coupling manner, a transfer function is defined from one of the transmission points to one of the reception points. Thus, transfer functions are defined from all of M transmission points to all of N reception points. Thus, the number of transmission signals is M, and the number of reception signals is N. A product of M-order vector composed of M transmission signals and a transfer matrix having N rows and M columns generates a N-order vector composed of N reception signals. When each component in the transfer matrix is known, the M-order vector is demodulated from the N-order vector. Further, based on the frequency characteristics of each component in the transfer matrix, the frequency band which is not suitable for the communication, is determined. Thus the sub carrier, which is not used in the communication, is determined.

When the multiple transmission points and multiple reception points are arranged in the electric power line network, both of the transmission diversity method and the reception diversity method can be performed. Further, the MIMO technique can be available. Thus, the transmission electric power is reduced, and the communication having good bit error rate characteristics is established. Thus, a signal leakage amount is reduced.

According to a second aspect of the present disclosure, a method of communicating with using an electric power line for a mobile body so that a first transmitting and receiving device transmits first information to a second transmitting and receiving device includes: coupling the first transmitting and receiving device in the mobile body with a plurality of first coupling points, which are arranged in an electric power line network including a plurality of electric power lines; coupling the second transmitting and receiving device in the mobile body with a plurality of second coupling points, which are arranged in the electric power line network; transmitting second information about transmission characteristics from the second transmitting and receiving device to the first transmitting and receiving device; modulating a plurality of transmission waves, which are to be transmitted from the first transmitting and receiving device via the transmission points, by the first transmitting and receiving device with using a transmission diversity method based on the second information about transmission characteristics; and demodulating a plurality of reception waves, which are received by the second transmitting and receiving device via the reception points, by the second transmitting and receiving device with using a reception diversity method.

Here, the electric power line is connected with a high frequency signal leased line via a filter or the like at the first coupling point and the second coupling point. Thus, the first and second coupling points may correspond to multiple transmission antennas and multiple, reception antennas.

The network includes multiple high frequency passes, which include the first and second coupling points. The number of the high frequency passes is obtained by multiplying the number of the first coupling points by the number of the second coupling points.

The information about the transmission characteristics includes information about quality of the transmission pass such as the transfer function of the transmission pass (attenuation characteristics) and the noise amplitude and instruction information relating to the communication method such as a modulation method of the first transmitting and receiving device determined based on the information about the quality of the transmission pass. For example, when the sounding packet as a well known data is transmitted from the first transmitting and receiving device to the second transmitting and receiving device. In the second transmitting and receiving device, based on reception conditions of the packet, the quality information of the transmission pass such as the attenuation property of the transmission pass and the noise amplitude information can be measured. The second transmitting and receiving device transmits the information about the quality of the transmission pass as the information of the transmission characteristics to the first transmitting and receiving device. The first transmitting and receiving device receives the information of the transmission characteristics as control information Then, the first transmitting and receiving device selects one or more transmission passes, which are suitably used for the communication. Further, the first transmitting and receiving device selects the communication method such as the modulation method, which is suitably used for transmitting data. Alternatively, in the second transmitting and receiving device, which detects the quality information of the transmission pass, one or more transmission passes which are suitably used for the communication, and the communication method may be determined. Accordingly, the second transmitting and receiving device transmits the instruction information of the transmission pass and the communication method as the information about the transmission characteristics to the first transmitting and receiving device. Based on the instruction information, the first transmitting and receiving device selects the transmission pass and the communication method. Accordingly, the information about the transmission characteristics includes information directly providing the transmission characteristics such as the transfer function of the transmission pass and the noise level, and further includes information providing the transmission characteristics such as the selected transmission pass and the selected modulation method.

When the multiple first and second coupling points are arranged in the electric power line network, both of the transmission diversity method and the reception diversity method can be performed. Further, the MIMO technique can be available. Thus, the transmission electric power is reduced, and the communication having good bit error rate characteristics is established. Thus a signal leakage amount is reduced.

Alternatively, the method may further include: monitoring the transmission characteristics by the first transmitting and receiving device based on the second information about transmission characteristics; and determining a sub carrier and an electric power of the sub carrier by the first transmitting and receiving device. The sub carrier is used for transmitting the first information. Here, the transmission pass characteristics represents information about the quality of the transmission pass such as the transfer function of the transmission pass such as the attenuation property and the frequency property, the noise level and the S/N ratio of the noise level including the frequency dependency of the S/N ratio. Accordingly, the transmission characteristics include the transmission pass characteristics. The sub carrier may be multiple sub carriers used for the modulation with the OFDM method. Alternatively, the sub carrier may be the carrier used for the spread spectrum method. Alternatively, the sub carrier may be carriers used for all frequency division multiplexing method. Accordingly, when the sub carrier is determined, the frequency band is also determined. In this case, when the data is transmitted from the first transmitting and receiving device to the second transmitting and receiving device, the transmitting method of the first transmitting and receiving device is variable based on the reception conditions of the second transmitting and receiving device. The bit error rate characteristics can be maintained to be equal to or better than a predetermined level when the data speed is adjusted. Thus, the first transmitting and receiving device determines the transmitting method based on the reception conditions of the second transmitting and receiving device.

Alternatively, the method may further include: monitoring the transmission characteristics by the second transmitting and receiving device; and determining a sub carrier and an electric power of the sub carrier by the second transmitting and receiving device. The sub carrier is used for transmitting the first information, and the second information about transmission characteristics includes information about the sub carrier and the electric power of the sub carrier. In this case, when the data is transmitted from the first transmitting and receiving device to the second transmitting and receiving device, the transmitting method of the first transmitting and receiving device is variable based on the reception conditions of the second transmitting and receiving device. The bit error rate characteristics can be maintained to be equal to or better than a predetermined level when the data speed is adjusted. Thus, the second transmitting and receiving device determines the transmitting method and transmits the instruction information to the first transmitting and receiving device.

Further, the modulating the plurality of transmission waves with using the transmission diversity method may be performed by a spread spectrum method, and the demodulating the plurality of reception waves with using a reception diversity method may be performed by the spread spectrum method.

Further, the modulating the plurality of transmission waves with using the transmission diversity method may be performed by an orthogonal frequency division multiplexing method, and the demodulating the plurality of reception waves with using a reception diversity method may be performed by the orthogonal frequency division multiplexing method.

Further, the modulating the plurality of transmission waves with using the transmission diversity method may be performed by one of a spread spectrum method and an orthogonal frequency division multiplexing method. The demodulating the plurality of reception waves with using a reception diversity method may be performed by the spread spectrum method and the orthogonal frequency division multiplexing method. In the modulating the plurality of transmission waves, the spread spectrum method and the orthogonal frequency division multiplexing method are switched from each other, and, in the demodulating the plurality of reception waves, the spread spectrum method and the orthogonal frequency division multiplexing method are switched from each other. Here, the spread spectrum method and the orthogonal frequency division multiplexing method are switched according to the reception conditions Specifically, the data rate of the spread spectrum method is smaller than the orthogonal frequency division multiplexing method. However, the tolerance against the reduction of the transmission characteristics in the spread spectrum method is larger than the orthogonal frequency division multiplexing method. Thus, the spread spectrum method and the orthogonal frequency division multiplexing method are switched in view of the data rate and the tolerance.

Further, the sub carrier, which is used for the orthogonal frequency division multiplexing method, may be variable at each first coupling point. Here, the feature that the sub carrier is variable means such that, if necessary, the sub carrier for use and the disuse sub carrier are determined. Specifically, the sub carrier is variable at each first coupling point. Thus, the sub carrier having low transmission characteristics is not used at each first coupling point. When it is determined whether the sub carrier is used or disused, the bit error rate characteristics of each sub carrier and average reception electric power may be used. Thus, the reduction of the transmission characteristics is restricted with maintaining the transmission electric power.

Furthermore, a transmission method of the sub carrier may be selected from the group consisting of the orthogonal frequency division multiplexing method, a single carrier transmission method and a code division multiple access method.

Further, the orthogonal frequency division multiplexing method may include a digital primary modulation method and the digital primary modulation method is variable at each sub carrier or at each first coupling point. Specifically, the digital primary modulation method is variable in each sub carrier or at each first coupling point. When the digital primary modulation method is selected from the group consisting of a 64-quadrature amplitude modulation method, a 16-quadrature amplitude modulation method, a quadrature phase shift keying method and a binary phase shift keying method, and the bit error rate of the 64-quadrature amplitude modulation method is sufficiently low, the 64-quadrature amplitude modulation method is selected. When the bit error rate of the 64-quadrature amplitude modulation method is larger than a predetermined threshold, the 16-quadrature amplitude modulation method is selected. When the bit error rate of the 16-quadrature amplitude modulation method is larger than a predetermined threshold, the quadrature phase shift keying method is selected. When the bit error rate of the quadrature phase shift keying method is larger than a predetermined threshold, the binary phase shift keying method is selected. Alternatively, the average reception electric power of each sub carrier may be used for switching among the 64-quadrature amplitude modulation method, the 16-quadrature amplitude modulation method, the quadrature phase shift keying method and the binary phase shift keying method. Thus, although the transmission electric power is constant, the bit error rate in each sub carrier or at each first coupling point is maintained to be equal to or larger than a predetermined level.

Furthermore, the digital primary modulation method is selected from the group consisting of a 64-quadrature amplitude modulation method, a 16-quadrature amplitude modulation method, a quadrature phase shift keying method and a binary phase shift keying method. Here, the feature that the digital primary modulation method is variable means such that the digital primary modulation method is selected in each sub carrier or at each transmission point.

Further, the orthogonal frequency division multiplexing method may include a digital primary modulation method, and the digital primary modulation method is variable at each sub carrier and at each first coupling point. Thus although the transmission electric power is constant, the bit error rate in each sub carrier and at each first coupling point is maintained to be equal to or larger than a predetermined level. Further, the digital primary modulation method is selected from the group consisting of a 64-quadrature amplitude modulation method, a 16-quadrature amplitude modulation method, a quadrature phase shift keying method and a binary phase shift keying method. Here, the feature that the digital primary modulation method is variable means such that the digital primary modulation method is selected in each sub carrier and at each transmission point.

Alternatively, the transmission diversity method and the reception diversity method may be executed with using a multiple-input multiple-output technique.

Alternatively, the multiple-input multiple-output technique may be performed by a transmission selection diversity method. Thus, although the transmission electric power is constant, the bit error rate is maintained to be equal to or larger than a predetermined level.

Alternatively, the first information may include a sounding packet as a well-known signal and noise condition information.

According to a third aspect of the present disclosure a method of communicating with using an electric power line for a mobile body so that a first transmitting and receiving device transmits a first information signal to the second transmitting and receiving device includes: coupling the first transmitting and receiving device in the mobile body with a plurality of first coupling points, which are arranged in an electric power line network including a plurality of electric power lines; coupling the second transmitting and receiving device in the mobile body with, a plurality of second coupling points, which are arranged in the electric power line network; modulating a predetermined data by the first transmitting and receiving device with using a multiple-input multiple-output technique and a orthogonal frequency division multiplexing method, wherein the predetermined data is a well-known data; transmitting the predetermined data from the first transmitting and receiving device to the second transmitting and receiving device; demodulating the predetermined data by the second transmitting and receiving device with using the multiple-input multiple-output technique and the orthogonal frequency division multiplexing method; determining transmission characteristics of each electric power line with a corresponding first coupling point and a corresponding second coupling point based on the predetermined data by the second transmitting and receiving device; determining a transmission level and a frequency of a sub carrier based on the transmission characteristics by the second transmitting and receiving device; modulating a second information signal by the second transmitting and receiving device with using the multiple-input multiple-output technique and the orthogonal frequency division multiplexing method, wherein the second information signal provides the transmission characteristics, which includes the transmission level and the frequency of the sub carrier; transmitting the second information signal from the second transmitting and receiving device to the first transmitting and receiving device; modulating the first information signal based on the transmission characteristics by the first transmitting and receiving device with using the multiple-input multiple-output technique and the orthogonal frequency, division multiplexing method; transmitting the first information signal from the first transmitting and receiving device to the second transmitting and receiving device; and demodulating the first information signal by the second transmitting and receiving device with using the multiple-input multiple-output technique and the orthogonal frequency division multiplexing method.

When the multiple first and second coupling points are arranged in the electric power line network, both of the transmission diversity method and the reception diversity method can be performed. Further, the MIMO technique can be available. Thus, the transmission electric power is reduced, and the communication having good bit error rate characteristics is established. Thus a signal leakage amount is reduced.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element are also within the spirit and scope of the invention.

What is claimed is:

1. A method of communicating with using an electric power line for a mobile body so that a first transmitting and receiving device transmits first information to a second transmitting and receiving device comprising:
coupling the first transmitting and receiving device in the mobile body with a plurality of first coupling points, which are arranged in an electric power line network including a plurality of electric power lines;
coupling the second transmitting and receiving device in the mobile body with a plurality of second coupling points, which are arranged in the electric power line network;
transmitting second information about transmission characteristics from the second transmitting and receiving device to the first transmitting and receiving device;
modulating a plurality of transmission waves, which are to be transmitted from the first transmitting and receiving device via the transmission points, by the first transmitting and receiving device with using a transmission diversity method based on the second information about transmission characteristics; and
demodulating a plurality of reception waves, which are received by the second transmitting and receiving device via the reception points, by the second transmitting and receiving device with using a reception diversity method.

2. The method according to claim 1, further comprising:
monitoring the transmission characteristics by the first transmitting and receiving device based on the second information about transmission characteristics; and
determining a sub carrier and an electric power of the sub carrier by the first transmitting and receiving device,
wherein the sub carrier is used for transmitting the first information.

3. The method according to claim 1, further comprising:
monitoring the transmission characteristics by the second transmitting and receiving device;
determining a sub carrier and an electric power of the sub carrier by the second transmitting and receiving device,
wherein the sub carrier is used for transmitting the first information, and
wherein the second information about transmission characteristics includes information about the sub carrier and the electric power of the sub carrier.

4. The method according to claim 3,
wherein the modulating the plurality of transmission waves with using the transmission diversity method is performed by a spread spectrum method and
wherein the demodulating the plurality of reception waves with using a reception diversity method is performed by the spread spectrum method.

5. The method according to claim 3,
wherein the modulating the plurality of transmission waves with using the transmission diversity method is performed by an orthogonal frequency division multiplexing method, and
wherein the demodulating the plurality of reception waves with using a reception diversity method is performed by the orthogonal frequency division multiplexing method.

6. The method according to claim 3,
wherein the modulating the plurality of transmission waves with using the transmission diversity method is performed by one of a spread spectrum method and an orthogonal frequency division multiplexing method,
wherein the demodulating the plurality of reception waves with using a reception diversity method is performed by the spread spectrum method and the orthogonal frequency division multiplexing method,
wherein, in the modulating the plurality of transmission waves, the spread spectrum method and the orthogonal frequency division multiplexing method are switched from each other, and
wherein, in the demodulating the plurality of reception waves, the spread spectrum method and the orthogonal frequency division multiplexing method are switched from each other.

7. The method according to claim 5,
wherein the sub carrier, which is used for the orthogonal frequency division multiplexing method, is variable at each first coupling point.

8. The method according to claim 7,
wherein a transmission method of the sub carrier is selected from the group consisting of the orthogonal frequency division multiplexing method, a single carrier transmission method and a code division multiple access method.

9. The method according to claim 5,
wherein the orthogonal frequency division multiplexing method includes a digital primary modulation method, and
wherein the digital primary modulation method is variable at each sub carrier or at each first coupling point.

10. The method according to claim 9,
wherein the digital primary modulation method is selected from the group consisting of a 64-quadrature amplitude modulation method 16-quadrature amplitude modulation method, a quadrature phase shift keying method and a binary phase shift keying method.

11. The method according to claim 5,
wherein the orthogonal frequency division multiplexing method includes a digital primary modulation method, and
wherein the digital primary modulation method is variable at each sub carrier and at each first coupling point.

12. The method according to claim 11,
wherein the digital primary modulation method is selected from the group consisting of a 64-quadrature amplitude modulation method, 16-quadrature amplitude modulation method, a quadrature phase shift keying method and a binary phase shift keying method.

13. The method according to claim 1,
wherein the transmission diversity method and the reception diversity method are executed with using a multiple-input multiple-output technique.

14. The method according to claim 13,
wherein the multiple-input multiple-output technique is performed by a transmission selection diversity method.

15. The method according to claim 3,
wherein the first information includes a sounding packet as a well-known signal and noise condition information.

16. A method of communicating with using an electric power line for a mobile body so that a first transmitting and receiving device transmits a first information signal to the second transmitting and receiving device comprising:
coupling the first transmitting and receiving device in the mobile body with a plurality of first coupling points, which are arranged in an electric power line network including a plurality of electric power lines;
coupling the second transmitting and receiving device in the mobile body with a plurality of second coupling points, which are arranged in the electric power line network;
modulating a predetermined data by the first transmitting and receiving device with using a multiple-input multiple-output technique and a orthogonal frequency division multiplexing method wherein the predetermined data is a well-known data;
transmitting the predetermined data from the first transmitting and receiving device to the second transmitting and receiving device;
demodulating the predetermined data by the second transmitting and receiving device with using the multiple-input multiple-output technique and the orthogonal frequency division multiplexing method;
determining transmission characteristics of each electric power line with a corresponding first coupling point and a corresponding second coupling point based on the predetermined data by the second transmitting and receiving device;
determining a transmission level and a frequency of a sub carrier based on the transmission characteristics by the second transmitting and receiving device;
modulating a second information signal by the second transmitting and receiving device with using the multiple-input multiple-output technique and the orthogonal frequency division multiplexing method, wherein the second information signal provides the transmission characteristics, which includes the transmission level and the frequency of the sub carrier;
transmitting the second information signal from the second transmitting and receiving device to the first transmitting and receiving device;
modulating the first information signal based on the transmission characteristics by the first transmitting and receiving device with using the multiple-input multiple-output technique and the orthogonal frequency division multiplexing method;
transmitting the first information signal from the first transmitting and receiving device to the second transmitting and receiving device; and
demodulating the first information signal by the second transmitting and receiving device with using the multiple-input multiple-output technique and the orthogonal frequency division multiplexing method.

17. A method of communicating with using an electric power line for a mobile body comprising:
coupling a transmitting device in the mobile body with a plurality of transmission points, which are arranged in an electric power line network including a plurality of electric power lines;
coupling a receiving device in the mobile body with a plurality of reception points, which are arranged in the electric power line network; and
demodulating a plurality of reception waves, which are received by the receiving device via the reception points, by the receiving device with using a reception diversity method.
